(19) United States
(12) Patent Application Publication
(10) Pub. No.: US 2026/0323695 A1
(43) Pub. Date: Oct. 15, 2026

(54) Power Saving in TXOP Sharing for non-AP Stations

(71) Applicant: Silicon Laboratories Inc., Austin, TX (US)

(72) Inventor: Nitesh Kumar Shah, Hyderabad (IN)

(21) Appl. No.: 19/179,143

(22) Filed: Apr. 15, 2025

(51) Int. Cl. H04W 74/0816; H04W 8/22; H04W 52/02

(52) U.S. Cl. CPC H04W 74/0816; H04W 8/22; H04W 52/0274

(57) ABSTRACT

A Wi-Fi device and methods of reducing power consumption when Triggered Transmission Opportunity (TXOP) Sharing (TXS) is used are disclosed. TXS is a procedure wherein a Wi-Fi access point may share its TXOP with a non-AP Wi-Fi device. Each non-access point Wi-Fi device monitors the Wi-Fi network for MU-RTS TXS Trigger Frames. Since the allocation period that is shared with the non-AP Wi-Fi device may be rather long, it is possible to save significant power by having other Wi-Fi devices enter a low power mode during these allocation periods. Based on the contents of these MU-RTS TXS Trigger Frames, these other Wi-Fi devices may decide to enter a low power mode.

### FIELD

This disclosure describes a system and various methods to reduce power consumption for devices operating in a Wi-Fi network with an Access Point that supports Triggered TXOP Sharing.

### BACKGROUND

The Wi-Fi protocol has continued to introduce new features. Some of these features allow support for low power devices, such as those that use battery power. These features allow a Wi-Fi device to enter a low power mode, and still remain connected to its associated access point.

Another interesting feature is the addition of Triggered TXOP Sharing support in extremely high throughput (EHT) devices. A Transmission Opportunity (TXOP) is a bounded time during which a specific access point has exclusive access to the wireless channel. This allows the access point to transmit latency-sensitive data in an efficient manner. Wi-Fi allows an EHT access point to share its Transmission Opportunity (TXOP) with a non-access point (non-AP) EHT device, also referred to as a non-AP EHT STA. This is referred to as Triggered TXOP Sharing (TXS). In practice, the access point may use some of its TXOP and then send a special message to a non-AP EHT device to allow it to use the remainder of the TXOP. This special message is referred to as a Multi-user Request to Send Triggered TXOP Sharing Trigger Frame (also referred to as a MU-RTS TXS Trigger Frame). The format of this frame is shown in FIG. 1. The MU-RTS TXS Trigger Frame includes a header with multiple fields. One field is referred to as the Frame Control field and contains, among others, a type and sub-type subfield. Specific values of the type and sub-type subfields denote this as a MU-RTS TXS Trigger Frame. The header includes an RA (Recipient Address) field, which is the MAC address of the device that is the recipient of this Frame. The header includes a TA (Transmitter Address) field, which is the MAC address of the Wi-Fi access point that is transmitting this frame. Additionally, the header includes a Common Info field, that includes a Trigger Type and TXS Mode subfield. A value of 3 in the Trigger Type indicates that this is a MU-RTS TXS Trigger Frame. The value of the TXS mode indicates the mode of sharing that is permitted. Specifically, a TXS Mode 1 indicates that the non-AP EHT device may use the remainder of the TXOP to transmit frames only to the access point. A TXS Mode 2 indicates that the non-AP EHT device may use the remainder of the TXOP to transmit frames to the access point and to other devices within the basic service set (BSS). A TXS Mode 3 is reserved. A TXS Mode 0 indicates that sharing is not being initiated. The header also includes a User Info List field, which contains an Allocation Duration field. This field represents the length of time that has been allocated to the non-AP EHT device, in units of 16 μsec. Thus, a value of 6 would indicate that the non-AP EHT device has access to the TXOP for 96 μsec.

Further, the Wi-Fi protocol allows the non-AP EHT device to return control back to the access point before the end of the allocation duration when TXS mode value is 2 in MU-RTS TXS Trigger Frame, if it has no additional data to transmit. This may be accomplished by transmitting a QoS Data or QoS Null frame that includes an HE variant HT Control field with a CAS Control subfield with the RDG/More PPDU subfield equal to 0 to the access point.

The capabilities of the access point and the other EHT devices may be contained with a structure referred to as the EHT Capabilities Element. These capabilities may include whether TXS is supported, and if so, which mode is supported. These capabilities also include whether returning the TXOP to the access point is supported.

While TXS allows improved efficiency for latency-sensitive data, it does not affect the power consumption of other devices in the network. Therefore, it would be advantageous if other devices may monitor the frames being transmitted and use this information to reduce their power consumption.

### SUMMARY

A Wi-Fi device and methods of reducing power consumption when Triggered Transmission Opportunity (TXOP) Sharing (TXS) is used are disclosed. TXS is a procedure wherein a Wi-Fi access point may share its TXOP with a non-AP Wi-Fi device. Each non-access point Wi-Fi device monitors the Wi-Fi network for MU-RTS TXS Trigger Frames. Since the allocation period that is shared with the non-AP Wi-Fi device may be rather long, it is possible to save significant power by having other Wi-Fi devices enter a low power mode during these allocation periods. Based on the contents of these MU-RTS TXS Trigger Frames, these other Wi-Fi devices may decide to enter a low power mode.

According to one embodiment, a Wi-Fi device is disclosed. The Wi-Fi device comprises a Wi-Fi network interface; a processing unit; and a memory device in communication with the processing unit comprising instructions, which when executed by the processing unit, enable the Wi-Fi device to: monitor a Wi-Fi network using the Wi-Fi network interface for a Multi-user Request to Send Triggered Transmission Opportunity Sharing (MU-RTS TXS) Trigger Frame intended for a second Wi-Fi device; and enter a low power mode if the MU-RTS TXS Trigger Frame is received and one or more criteria are met. In some embodiments, the MU-RTS TXS Trigger Frame comprises an Allocation Duration field, and the Wi-Fi device exits low power mode upon expiration of an Allocation period, determined based on the Allocation Duration field. In some embodiments, the MU-RTS TXS Trigger Frame comprises a TXS Mode field, and the Wi-Fi device enters the low power mode if the TXS Mode field indicates TXS Mode 1. In some embodiments, the MU-RTS TXS Trigger Frame comprises a TXS Mode field, and the Wi-Fi device enters the low power mode if the TXS Mode field indicates TXS Mode 2 and the Wi-Fi device does not have a Tunneled Direct Link Setup (TDLS) connection with the second Wi-Fi device. In certain embodiments, the Wi-Fi device enters the low power mode if the TXS Mode field indicates TXS Mode 2, the Wi-Fi device has a TDLS connection with the second Wi-Fi device, and the Wi-Fi device does not have any data to transmit to or receive from the second Wi-Fi device. In some embodiments, the MU-RTS TXS Trigger Frame comprises a TXS Mode field and an Allocation Duration field, and the Wi-Fi device enters the low power mode if the TXS Mode field indicates TXS Mode 1 and a value of the Allocation Duration field is greater than a predetermined threshold. In some embodiments, the MU-RTS TXS Trigger Frame comprises a TXS Mode field and an Allocation Duration field, and the Wi-Fi device enters the low power mode if the TXS Mode field indicates TXS Mode 2, the Wi-Fi device does not have a Tunneled Direct Link Setup (TDLS) connection with the second Wi-Fi device and a value of the Allocation Duration field is greater than a predetermined threshold. In certain embodiments, the Wi-Fi device enters the low power mode if the TXS Mode field indicates TXS Mode 2, the Wi-Fi device has a TDLS connection with the second Wi-Fi device, the Wi-Fi device does not have any data to transmit to or receive from the second Wi-Fi device and the value of the Allocation Duration field is greater than the predetermined threshold. In some embodiments, the Wi-Fi device provides an indication to an Wi-Fi access point that it supports entering low power mode based on information in the MU-RTS TXS Trigger Frame. In certain embodiments, the indication is provided in a field in an Extremely High Throughput (EHT) Capabilities Element that is transmitted to the Wi-Fi access point.

According to another embodiment, a method of operating a Wi-Fi network is disclosed. The method comprises transmitting, from a Wi-Fi access point, a Multi-user Request to Send Transmission Opportunity Sharing (MU-RTS TXS) Trigger Frame to a second Wi-Fi device, wherein the MU-RTS TXS Trigger Frame comprises a TXS Mode field; observing, at a first Wi-Fi device, the MU-RTS TXS Trigger Frame; determining, at the first Wi-Fi device, a TXS Mode contained in the MU-RTS TXS Trigger Frame; and entering, at the first Wi-Fi device, a low power mode if one or more criteria are met. In some embodiments, the MU-RTS TXS Trigger Frame comprises an Allocation Duration field, and the first Wi-Fi device exits low power mode upon expiration of an allocation period, determined based on the Allocation Duration field. In some embodiments, the first Wi-Fi device enters the low power mode if the TXS Mode field indicates TXS Mode 1. In some embodiments, the first Wi-Fi device enters the low power mode if the TXS Mode field indicates TXS Mode 2 and the first Wi-Fi device does not have a Tunneled Direct Link Setup (TDLS) connection with the second Wi-Fi device. In certain embodiments, the first Wi-Fi device enters the low power mode if the TXS Mode field indicates TXS Mode 2, the first Wi-Fi device has a TDLS connection with the second Wi-Fi device, and the first Wi-Fi device does not have any data to transmit to or receive from the second Wi-Fi device. In some embodiments, the MU-RTS TXS Trigger Frame comprises an Allocation Duration field and wherein the first Wi-Fi device enters the low power mode only if a value of the Allocation Duration field contained in the MU-RTS TXS Trigger Frame is greater than a predetermined threshold. In some embodiments, the first Wi-Fi device informs the Wi-Fi access point that it is capable of entering low power mode based on information in the MU-RTS TXS Trigger Frame. In certain embodiments, the MU-RTS TXS Trigger Frame comprises an Allocation Duration field defining an allocation period, wherein the second Wi-Fi device returns a portion of the allocation period to the Wi-Fi access point; and if the first Wi-Fi device has informed the Wi-Fi access point that it is capable of entering low power mode, the Wi-Fi access point modifies its behavior during a remainder of the allocation period. In certain embodiments, the Wi-Fi access point does not retry transmissions to the first Wi-Fi device during the remainder of the allocation period.

According to another embodiment, a network device is disclosed. The network device comprises a network interface; a processing unit; and a memory device in communication with the processing unit comprising instructions, which when executed by the processing unit, enable the network device to: monitor a network using the network interface for a frame indicating that a Transmission Opportunity is being shared with a second network device; and enter a low power mode for a remainder of the Transmission Opportunity if the frame is received and one or more criteria are met.

### BRIEF DESCRIPTION OF THE DRAWINGS

For a better understanding of the present disclosure, reference is made to the accompanying drawings, in which like elements are referenced with like numerals, and in which:

FIG. 1 shows the format of a MU-RTS TXS Trigger Frame;

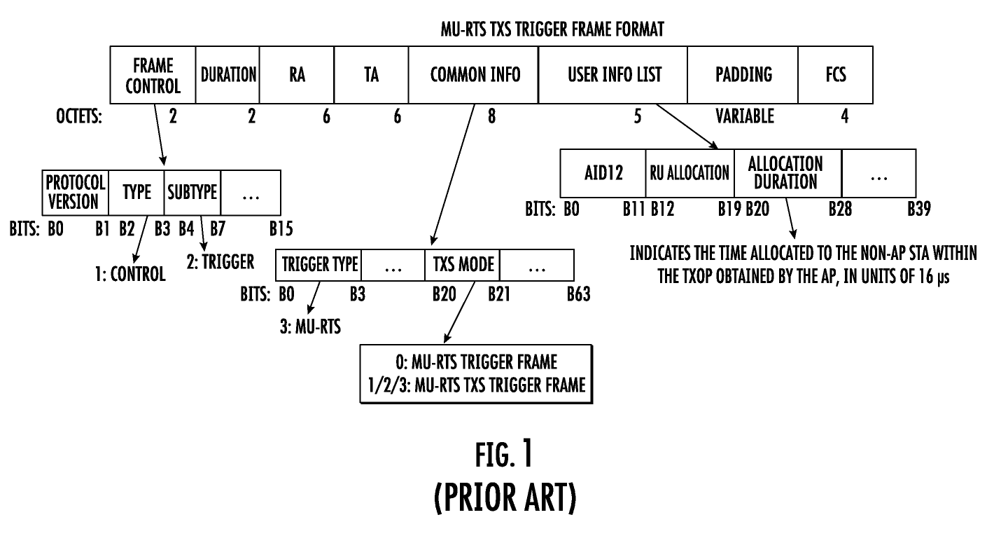

FIG. 2 shows a block diagram of a Wi-Fi network device;

FIG. 3 shows a Wi-Fi network with a Wi-Fi EHT access point, and two non-AP EHT devices;

FIG. 4 shows the operation of the first Wi-Fi device according to one embodiment;

FIGS. 5A-5B show a modification to the EHT Capabilities Element;

FIG. 6 shows the operation of the Wi-Fi access point according to one embodiment; and

FIG. 7 shows the operation of the Wi-Fi access point according to a second embodiment.

### DETAILED DESCRIPTION

This disclosure presents a system and method that describes techniques to reduce power consumption when using Triggered Transmission Opportunity Sharing (TXS) in a Wi-Fi network.

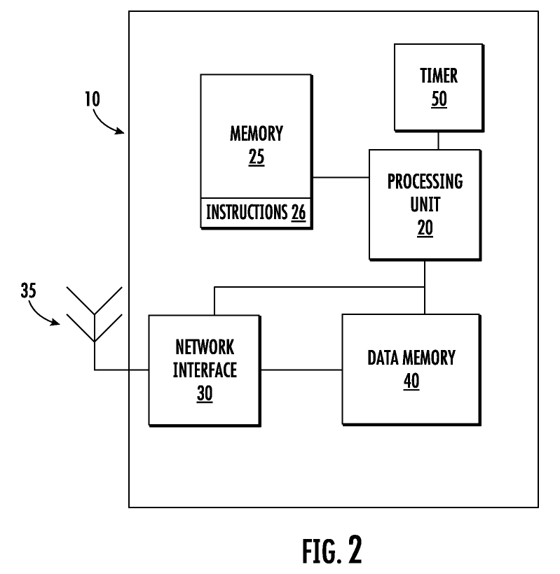

FIG. 2 shows a block diagram of a representative Wi-Fi device 10 that may be used to implement the disclosed method of minimizing power consumption in a Wi-Fi device during TXS.

The Wi-Fi device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 2. The second computer readable non-transitory media may be a CDROM, or a different memory device, which is located remote from the Wi-Fi device 10. The instructions contained on this second computer readable non-transitory media may be downloaded onto the memory device 25 to allow execution of the instructions by the Wi-Fi device 10.

The Wi-Fi device 10 also includes a Wi-Fi network interface 30 that connects with a Wi-Fi network using an antenna 35.

The Wi-Fi device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network.

The Wi-Fi device 10 may operate in one of several modes. In normal operating mode, all of the components may be powered on and completely functional. In a low power mode, components within the device are powered off or placed in a low power state. For example, the Wi-Fi network interface 30 may be powered down so it is unable to receive or transmit on the Wi-Fi network. Additionally, the processing unit 20 may be powered off or enter a low power mode.

The Wi-Fi device 10 also includes a timer 50, that may be used to time various events or actions. Further, in some embodiments, the timer 50 may be used to allow the Wi-Fi device 10 to exit the low power mode.

Although not shown, the Wi-Fi device 10 also has a power supply, which may be a battery.

While the processing unit 20, the memory device 25, the Wi-Fi network interface 30, the timer 50 and the data memory device 40 are shown in FIG. 2 as separate components, it is understood that some or all of these components may be integrated into a single electronic component. Rather, FIG. 2 is used to illustrate the functionality of the Wi-Fi device 10, not its physical configuration. As noted above, the Wi-Fi device 10 may support one or more low power modes. For example, in some embodiments, in low power mode, the Wi-Fi device 10 may disable or remove power to some of its components, such as the Wi-Fi network interface 30 and the processing unit 20. Thus, when in this low power mode, the Wi-Fi device 10 consumes less power, but cannot receive any frame transmitted on the Wi-Fi network.

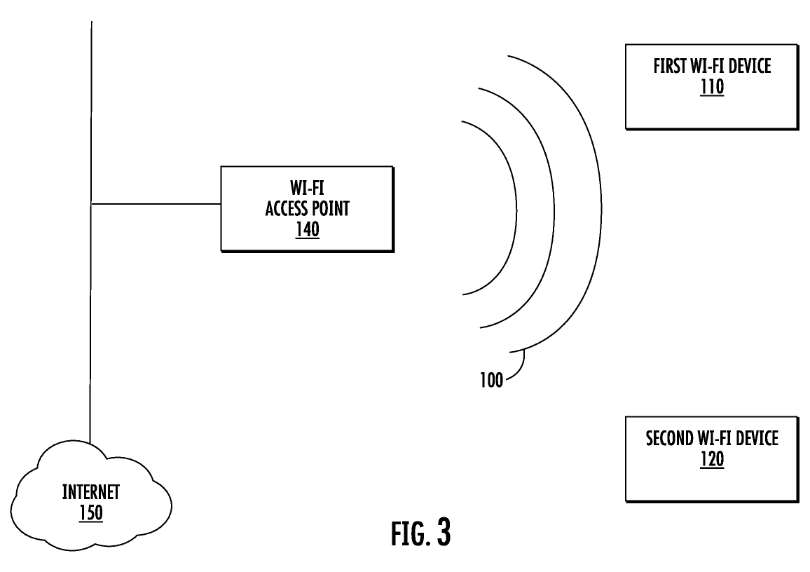

FIG. 3 shows a network 100 that utilizes Wi-Fi. The network 100 includes a first Wi-Fi device 110, a second Wi-Fi device 120 and a Wi-Fi access point 140. The Wi-Fi devices may be extremely high throughput (EHT) devices that are not access points, or non-AP EHT devices. The Wi-Fi access point 140, which is an EHT device, may have access to the internet 150.

In this example, the Wi-Fi access point 140 may share its TXOP with the second Wi-Fi device 120. Thus, to initiate this sharing, the Wi-Fi access point 140 may transmit a MU-RTS TXS Trigger Frame to the second Wi-Fi device 120. The MAC address of the second Wi-Fi device 120 is contained in the RA field of the Trigger Frame. The MU-RTS TXS Trigger Frame also indicates which TXS mode is being used, and the duration of this allocation.

If the TXS mode is set to 1, this indicates that all of the data transmitted by the second Wi-Fi device 120 will be sent to the Wi-Fi access point 140. Thus, in this case, the first Wi-Fi device 110 will not receive any frames from the second Wi-Fi device 120 for the remainder of the allocation period. Thus, if desired, the first Wi-Fi device 110 may enter the low power mode until the end of the allocation period. If the allocation period is sufficiently long, this may represent a large power savings. However, if the allocation period is relatively short, the first Wi-Fi device 110 may choose to remain in active mode.

On the other hand, if the TXS mode is set to 2, this indicates that the second Wi-Fi device 120 may transmit data to the Wi-Fi access point 140 and any other devices within the BSS with which it has a Tunneled Direct Link Setup (TDLS) connection. A TDLS connection is one in which two Wi-Fi devices may communicate directly with one another, bypassing the Wi-Fi access point. Thus, if the second Wi-Fi device 120 does not have a TDLS connection to the first Wi-Fi device 110, the first Wi-Fi device 110 will not receive any frames from the second Wi-Fi device 120 during the allocation period. Thus, if desired, the first Wi-Fi device 110 may enter the low power mode until the end of the allocation period. If the allocation period is sufficiently long, this may represent a large power savings. However, if the allocation period is relatively short, the first Wi-Fi device 110 may choose to remain in active mode.

Additionally, even if the first Wi-Fi device 110 has a TDLS connection with the second Wi-Fi device 120, it may note that it has no data to transmit to the second Wi-Fi device 120, and is not expecting any data from the second Wi-Fi device 120. In this case, the first Wi-Fi device 110 is not expecting to receive any frames from the second Wi-Fi device 120 during the allocation period. Thus, if desired, the first Wi-Fi device 110 may enter the low power mode until the end of the allocation period. If the allocation period is sufficiently long, this may represent a large power savings. However, if the allocation period is relatively short, the first Wi-Fi device 110 may choose to remain in active mode.

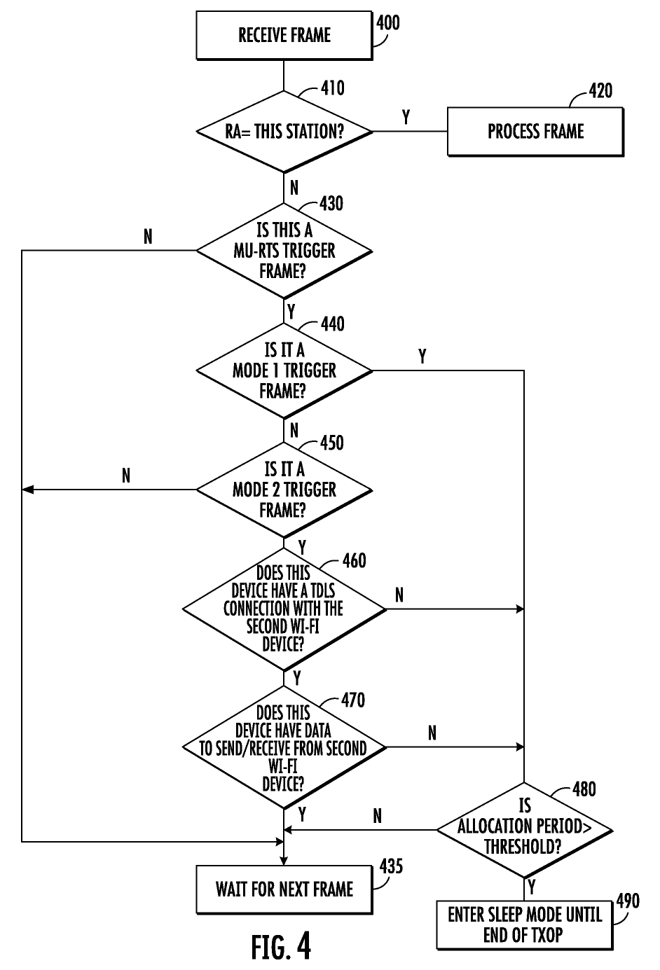

Thus, there are many opportunities for the first Wi-Fi device 110 to conserve power, based on the contents of the MU-RTS TXS Trigger Frame. A flowchart showing this operation of the first Wi-Fi device 110 is shown in FIG. 4. First, as shown in Box 400, the first Wi-Fi device 110 receives a frame from the Wi-Fi access point 140. As shown in Decision Box 410, the first Wi-Fi device 110 checks if this frame is intended for this device by checking the RA field. If the frame is for this device, the frame is processed normally, as shown in Box 420. If the frame is not for the first Wi-Fi device 110, the first Wi-Fi device 110 checks if this is a MU-RTS TXS Trigger Frame, as shown in Decision Box 430. If it is not a MU-RTS TXS Trigger Frame, the first Wi-Fi device 110 simply waits for the next frame, as shown in Box 435. If, however, this frame is a MU-RTS TXS Trigger Frame, the first Wi-Fi device 110 checks if this Trigger Frame indicates that it is a TXS Mode 1, as shown in Decision Box 440. If so, the first Wi-Fi device 110 knows that it will not receive any frames from the second Wi-Fi device 120 for the remainder of the allocation period. In some embodiments, as shown in Decision Box 480, the first Wi-Fi device 110 checks if the allocation period (found in the MU-RTS TXS Trigger Frame, as described above) is greater than some predetermined threshold. If so, the first Wi-Fi device 110 enters the low power mode, as shown in Box 490. If the allocation period is less than the predetermined threshold, the first Wi-Fi device 110 may simply stay in active mode and wait for the next frame, as shown in Box 435. Note that in certain embodiments, the first Wi-Fi device 110 does not perform this check against a predetermined threshold. Rather, in these embodiments, the first Wi-Fi device 110 enters low power mode, regardless of the value of the allocation period.

Returning to Decision Box 440, if the TXS mode is not 1, the first Wi-Fi device 110 checks if the Trigger Frame is TXS Mode 2, as shown in Decision Box 450. If it is not TXS Mode 2, this indicates that this Trigger Frame does not initiate Triggered TXOP sharing. Thus, the first Wi-Fi device 110 simply waits for the next frame, as shown in Box 435. If, however, the Trigger Frame is TXS Mode 2, the first Wi-Fi device 110 checks if it has a TDLS connection to the second Wi-Fi device 120 (which is identified by the RA field), as shown in Decision Box 460. If it does not have a TDLS connection to the second Wi-Fi device 120, the first Wi-Fi device 110 knows that it will not receive any frames from the second Wi-Fi device 120 for the remainder of the allocation period. As described above, in some embodiments, the first Wi-Fi device 110 may compare the allocation period to a predetermined threshold (Decision Box 480) to determine whether to enter low power mode (Box 490). In some embodiments, the first Wi-Fi device 110 enters low power mode regardless of the value of the allocation period, as described above. Alternatively, if the allocation period is less than the predetermined threshold, the first Wi-Fi device 110 may simply stay in active mode and wait for the next frame, as shown in Box 435.

Finally, if the Trigger Frame is TXS Mode 2 and the first Wi-Fi device 110 has a TDLS connection to the second Wi-Fi device 120, the first Wi-Fi device 110 may optionally check if it has any data for the second Wi-Fi device 120 or is expecting any data from the second Wi-Fi device 120, as shown in Decision Box 470. If it determines that it may receive data from the second Wi-Fi device 120, the first Wi-Fi device 110 may simply wait for the next frame, as shown in Box 435. If the first Wi-Fi device 110 is not expecting any transmissions from the second Wi-Fi device 120, it may compare the allocation period to a predetermined threshold (Decision Box 480) to determine whether to enter low power mode (Box 490). In some embodiments, the first Wi-Fi device 110 enters low power mode regardless of the value of the allocation period, as described above. Alternatively, if the allocation period is less than the predetermined threshold, the first Wi-Fi device 110 may simply stay in active mode and wait for the next frame, as shown in Box 435.

Note that in some embodiments, Decision Box 470 is not executed. Rather, if the MU-RTS TXS Trigger Frame is TXS Mode 2 and the first Wi-Fi device 110 has a TDLS connection with the second Wi-Fi device 120, the first Wi-Fi device 110 may simply wait for the next frame, as shown in Box 435.

Note that the first Wi-Fi device 110 may only execute the sequence shown in FIG. 4 if the Wi-Fi access point 140 supports TXS mode 1 or TXS mode 2, as indicated in the EHT Capabilities Element.

Furthermore, while FIG. 4 assumes that the device operates on a Wi-Fi network, it is understood that this sequence of operations may be implemented for any network device that operates on a network that supports Transmission Opportunity sharing.

The operation of the first Wi-Fi device 110 assumes that the second Wi-Fi device 120 retains the TXOP for the entire allocation period. However, in some embodiments, it is possible for the second Wi-Fi device 120 to return an unused portion of the allocation period back to the Wi-Fi access point 140. For example, the second Wi-Fi device 120 may transmit a QoS Data or QoS Null frame that includes an HE variant HT Control field with a CAS Control subfield with the RDG/More PPDU subfield equal to 0 to the Wi-Fi access point 140. If this happens, the Wi-Fi access point 140 regains the TXOP and is free to transmit frames to any device in its BSS.

However, if the first Wi-Fi device 110 has entered low power mode based on the earlier MU-RTS TXS Trigger Frame, it will be unable to receive any frames from the Wi-Fi access point 140 until the allocation period expires. Thus, it is possible that the Wi-Fi access point 140 may attempt to transmit multiple frames that are not received by the first Wi-Fi device 110 during this time.

To address this potential issue, it may be advantageous for the first Wi-Fi device 110 to inform the Wi-Fi access point 140 that it employs the power savings technique shown in FIG. 4. There are various ways in which this may be done. For example, during certain management frames, such as Probe Request frames, Association Request frames and Reassociation Request frames, the first Wi-Fi device 110 transmits its EHT Capabilities Element to the Wi-Fi access point 140. Thus, in certain embodiments, a bit in the EHT Capabilities Element may be defined to indicate that a non-AP EHT device supports this power savings technique.

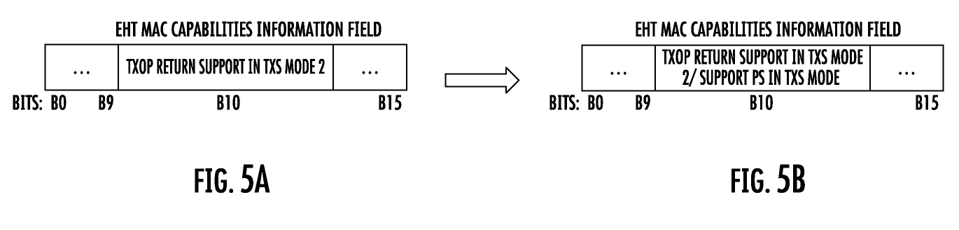

As an example, as shown in FIG. 5A, the EHT Capabilities Element currently includes a bit that is defined as “TXOP Return Support in TXS Mode 2”. This bit is set by access points to indicate that the non-AP EHT device may return an unused portion of the allocation period back to them. However, this bit is not used by non-access points. Thus, in one embodiment, shown in FIG. 5B, this bit is redefined for non-access points to indicate whether the non-AP EHT Device supports the power savings (PS) mode in TXS as described above. The definition of the bit for access points is unchanged.

Of course, there are other mechanisms by which the first Wi-Fi device 110 may inform the Wi-Fi access point 140 that it employs the power savings technique shown in FIG. 4. For example, the first Wi-Fi device 110 may use some other fields in the EHT Capabilities element or in some other elements.

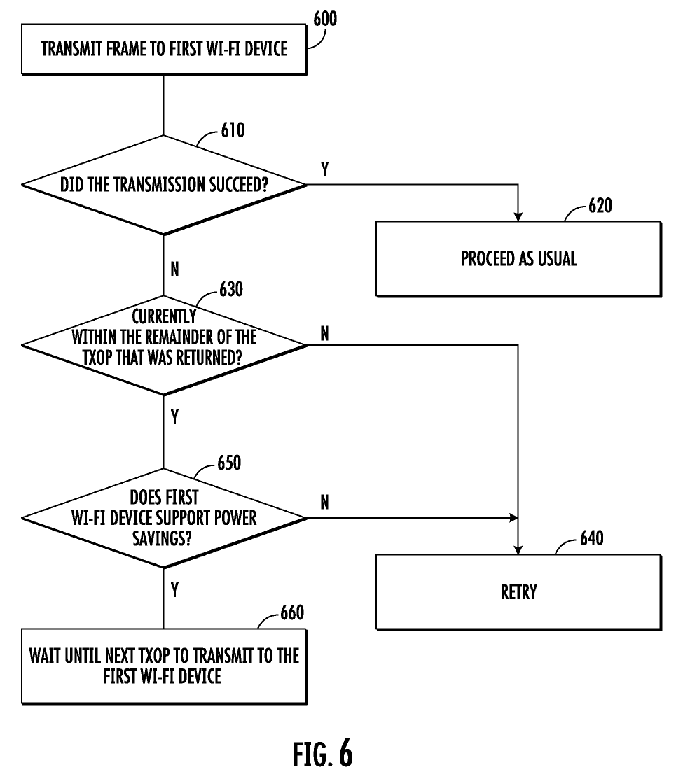

Based on this information, the Wi-Fi access point 140 may modify its behavior with respect to the first Wi-Fi device 110. For example, assume that the Wi-Fi access point 140 attempts to communicate with the first Wi-Fi device 110 during the remainder of the allocation period that has been returned to the Wi-Fi access point 140 by the second Wi-Fi device 120. As noted above, the first Wi-Fi device 110 may not respond if it is in the low power mode. However, if the Wi-Fi access point 140 is aware that this device implements the power saving technique of FIG. 4, it may refrain from transmitting any additional frames to the first Wi-Fi device 110 until the allocation period has expired. This is shown in FIG. 6. First, as shown in Box 600, the Wi-Fi access point 140 may attempt to transmit a frame to the first Wi-Fi device 110. The Wi-Fi access point 140 checks if the transmission was successful, as shown in Decision Box 610. If the transmission was successful, the Wi-Fi access point 140 proceeds as normal, as shown in Box 620. However, if the transmission fails, the Wi-Fi access point 140 attempts to determine the reason for the failure. First, the Wi-Fi access point 140 checks if this transmission occurred during the remainder of the allocation period that was returned to it by the second Wi-Fi device 120, as shown in Decision Box 630. If the transmission did not occur during this time interval, the Wi-Fi access point 140 may simply retry the transmission, as shown in Box 640. If the transmission did occur during this time interval, the Wi-Fi access point 140 then checks if the first Wi-Fi device 110 supports the power savings technique shown in FIG. 4, as shown in Decision Box 650. If it does not, the Wi-Fi access point 140 may simply retry the transmission, as shown in Box 640. However, if the first Wi-Fi device 110 does support this power saving technique, the Wi-Fi access point 140 may delay the retransmission of this frame until the next Transmission Opportunity (TXOP), as shown in Box 660.

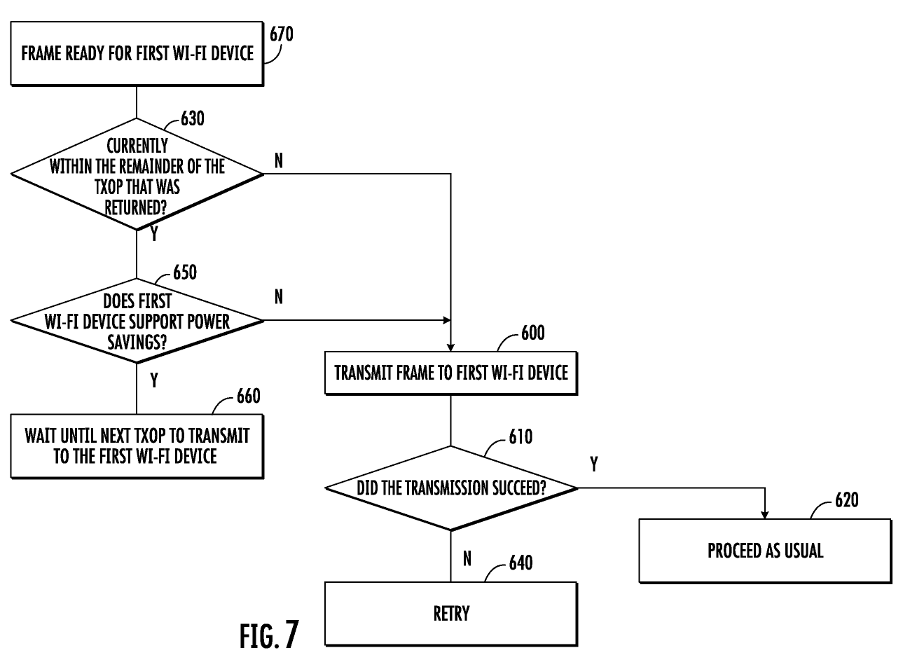

The Wi-Fi access point 140 may modify its behavior in other ways. For example, the Wi-Fi access point 140 may perform the checks shown in Decision Boxes 630 and 650 prior to the initial transmission to the first Wi-Fi device 110. This embodiment is shown in FIG. 7. First, the Wi-Fi access point 140 has a frame ready to transmit to the first Wi-Fi device 110, as shown in Box 670. It then performs the checks described above with respect to Decision Boxes 630 and 650 regarding the time interval of the proposed transmission and whether the first Wi-Fi device 110 supports the power saving technique. If the transmission is scheduled during the remainder of the allocation period that has been returned to the Wi-Fi access point 140 and the first Wi-Fi device 110 supports this power savings technique, the Wi-Fi access point 140 delays transmission of the frame until the next TXOP. However, if both of these conditions are not true, the Wi-Fi access point 140 proceeds as usual.

This system and method has many advantages. Currently, during TXOP sharing, the other Wi-Fi devices remain active, even though, in many scenarios, they will not receive any frames during the allocation period. Further, the allocation fields may be quite long, such as 50 μseconds or more. Thus, entering low power mode for these extended durations may have a great effect on battery life. Further, if implemented as described herein, there is minimal impact on the operation of the Wi-Fi access point.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A Wi-Fi device, comprising:
a Wi-Fi network interface;
a processing unit; and
a memory device in communication with the processing unit comprising instructions, which when executed by the processing unit, enable the Wi-Fi device to:
monitor a Wi-Fi network using the Wi-Fi network interface for a Multi-user Request to Send Triggered Transmission Opportunity Sharing (MU-RTS TXS) Trigger Frame intended for a second Wi-Fi device; and
enter a low power mode if the MU-RTS TXS Trigger Frame is received and one or more criteria are met.

2. The Wi-Fi device of claim 1, wherein the MU-RTS TXS Trigger Frame comprises an Allocation Duration field, and the Wi-Fi device exits low power mode upon expiration of an Allocation period, determined based on the Allocation Duration field.

3. The Wi-Fi device of claim 1, wherein the MU-RTS TXS Trigger Frame comprises a TXS Mode field, and the Wi-Fi device enters the low power mode if the TXS Mode field indicates TXS Mode 1.

4. The Wi-Fi device of claim 1, wherein the MU-RTS TXS Trigger Frame comprises a TXS Mode field, and the Wi-Fi device enters the low power mode if the TXS Mode field indicates TXS Mode 2 and the Wi-Fi device does not have a Tunneled Direct Link Setup (TDLS) connection with the second Wi-Fi device.

5. The Wi-Fi device of claim 4, wherein the Wi-Fi device enters the low power mode if the TXS Mode field indicates TXS Mode 2, the Wi-Fi device has a TDLS connection with the second Wi-Fi device, and the Wi-Fi device does not have any data to transmit to or receive from the second Wi-Fi device.

6. The Wi-Fi device of claim 1, wherein the MU-RTS TXS Trigger Frame comprises a TXS Mode field and an Allocation Duration field, and the Wi-Fi device enters the low power mode if the TXS Mode field indicates TXS Mode 1 and a value of the Allocation Duration field is greater than a predetermined threshold.

7. The Wi-Fi device of claim 1, wherein the MU-RTS TXS Trigger Frame comprises a TXS Mode field and an Allocation Duration field, and the Wi-Fi device enters the low power mode if the TXS Mode field indicates TXS Mode 2, the Wi-Fi device does not have a Tunneled Direct Link Setup (TDLS) connection with the second Wi-Fi device and a value of the Allocation Duration field is greater than a predetermined threshold.

8. The Wi-Fi device of claim 7, wherein the Wi-Fi device enters the low power mode if the TXS Mode field indicates TXS Mode 2, the Wi-Fi device has a TDLS connection with the second Wi-Fi device, the Wi-Fi device does not have any data to transmit to or receive from the second Wi-Fi device and the value of the Allocation Duration field is greater than the predetermined threshold.

9. The Wi-Fi device of claim 1, wherein the Wi-Fi device provides an indication to an Wi-Fi access point that it supports entering low power mode based on information in the MU-RTS TXS Trigger Frame.

10. The Wi-Fi device of claim 9, wherein the indication is provided in a field in an Extremely High Throughput (EHT) Capabilities Element that is transmitted to the Wi-Fi access point.

11. A method of operating a Wi-Fi network, comprising:
transmitting, from a Wi-Fi access point, a Multi-user Request to Send Transmission Opportunity Sharing (MU-RTS TXS) Trigger Frame to a second Wi-Fi device, wherein the MU-RTS TXS Trigger Frame comprises a TXS Mode field;
observing, at a first Wi-Fi device, the MU-RTS TXS Trigger Frame;
determining, at the first Wi-Fi device, a TXS Mode contained in the MU-RTS TXS Trigger Frame; and
entering, at the first Wi-Fi device, a low power mode if one or more criteria are met.

12. The method of claim 11, wherein the MU-RTS TXS Trigger Frame comprises an Allocation Duration field, and the first Wi-Fi device exits low power mode upon expiration of an allocation period, determined based on the Allocation Duration field.

13. The method of claim 11, wherein the first Wi-Fi device enters the low power mode if the TXS Mode field indicates TXS Mode 1.

14. The method of claim 11, wherein the first Wi-Fi device enters the low power mode if the TXS Mode field indicates TXS Mode 2 and the first Wi-Fi device does not have a Tunneled Direct Link Setup (TDLS) connection with the second Wi-Fi device.

15. The method of claim 14, wherein the first Wi-Fi device enters the low power mode if the TXS Mode field indicates TXS Mode 2, the first Wi-Fi device has a TDLS connection with the second Wi-Fi device, and the first Wi-Fi device does not have any data to transmit to or receive from the second Wi-Fi device.

16. The method of claim 11, wherein the MU-RTS TXS Trigger Frame comprises an Allocation Duration field and wherein the first Wi-Fi device enters the low power mode only if a value of the Allocation Duration field contained in the MU-RTS TXS Trigger Frame is greater than a predetermined threshold.

17. The method of claim 11, wherein the first Wi-Fi device informs the Wi-Fi access point that it is capable of entering low power mode based on information in the MU-RTS TXS Trigger Frame.

18. The method of claim 17, wherein the MU-RTS TXS Trigger Frame comprises an Allocation Duration field defining an allocation period, wherein the second Wi-Fi device returns a portion of the allocation period to the Wi-Fi access point; and
wherein, if the first Wi-Fi device has informed the Wi-Fi access point that it is capable of entering low power mode, the Wi-Fi access point modifies its behavior during a remainder of the allocation period.

19. The method of claim 18, wherein the Wi-Fi access point does not retry transmissions to the first Wi-Fi device during the remainder of the allocation period.

20. A network device, comprising:
a network interface;
a processing unit; and
a memory device in communication with the processing unit comprising instructions, which when executed by the processing unit, enable the network device to:
monitor a network using the network interface for a frame indicating that a Transmission Opportunity is being shared with a second network device; and
enter a low power mode for a remainder of the Transmission Opportunity if the frame is received and one or more criteria are met.
